(19) United States
(12) Patent Application Publication
(10) Pub. No.: US 2026/0327161 A1
(43) Pub. Date: Oct. 22, 2026

(54) DISPERSIBLE BAUXITE GRANULES AND METHODS FOR AMENDING SOIL WITH BAUXITE

(71) Applicant: PHOSPHOLUTIONS INC., State College, PA (US)

(72) Inventors: Kyle J. ISAACSON, Parrish, FL (US); Pauline WELIKHE, Bellefonte, PA (US); Aaron WALTZ, Rockford, IL (US); Carlos A. LEÓN Y LEÓN, Bellefonte, PA (US)

(21) Appl. No.: 19/104,580

(22) PCT Filed: Aug. 16, 2023
(86) PCT No.: PCT/US2023/030358

§ 371 Date: Feb. 18, 2025

Related U.S. Application Data
(60) Provisional application No. 63/399,383, filed on Aug. 19, 2022.

(51) Int. Cl. C05G 3/80; A01C 21/00; C05B 17/00; C05G 5/12; C09K 17/04; C09K 17/08

(52) U.S. Cl. CPC C05G 3/80; A01C 21/00; C05B 17/00; C05G 5/12; C09K 17/04; C09K 17/08

(57) ABSTRACT

Dispersible bauxite granules are disclosed, including at least one bauxite domain and at least one nutrient domain, at least one pesticide domain, at least one biological additive domain, at least one sorbent domain, or combinations thereof present in the dispersible bauxite granule as distinct domains clustered together, or bauxite particles and water-soluble binder agglomerating the plurality of bauxite particles into the dispersible bauxite granules, wherein the bauxite particles are free of chemical modification with NaOH. A method for amending soil with bauxite is disclosed, including applying bauxite to soil, wherein the bauxite is mineral bauxite free of chemical modification with NaOH, the bauxite has a moisture content, by weight, of less than 10%, the bauxite has a size of less than 0.6 mm, and the bauxite increases the efficacy of phosphate present in the soil by at least 5%.

### RELATED APPLICATIONS

This application claims the benefit of and priority to U.S. Provisional Patent Application No. 63/399,383, filed Aug. 19, 2022, entitled “Dispersible Bauxite Granules and Methods for Amending Soil with Bauxite,” which is hereby incorporated by reference in its entirety.

### FIELD OF THE INVENTION

This application is directed to dispersible bauxite granules and methods for amending soil with bauxite. In particular, this application is directed to dispersible bauxite granules with at least one bauxite domain and at least one supplemental domain clustered together as distinct domains, dispersible bauxite granules free of chemical modification with NaOH agglomerated with water-soluble binder, and methods for amending soil with bauxite free of chemical modification with NaOH.

### BACKGROUND OF THE INVENTION

Phosphorus is a key nutrient for plant growth. Phosphorus must reside in a soluble form to be taken up by crops. While most soils exhibit a long history of phosphorus application, only a small fraction of the phosphorus remains in a soluble, plant-available form. In general, the vast majority of phosphorus is precipitated and/or adsorbed by soil particles upon application. Soils with a high phosphorus buffering capacity (often approximated by the phosphorus buffering index (“PBI”)) quickly and tightly bind phosphorus fertilizer, making it unavailable to plants. High PBI soil systems require excessive phosphorus application quantities in order to achieve adequate soluble phosphorus reservoirs to achieve maximum crop yields. This disproportionate phosphorus applied to phosphorus uptake ratio results in increases in phosphorus runoff, exacerbating already fragile environmental systems.

In contrast, an optimal soil system would regulate phosphorus buffering capacity by adsorbing phosphorus in a readily-accessible arrangement to allow quick desorption and solubility when triggered by plant needs. Certain soil amendments, such as activated alumina, attempt to simulate this phosphorus regulation property, as they display both phosphorus concentration-dependent and pH-dependent desorption characteristics. However, high manufacturing carbon footprints and financial costs render these systems inopportune for large-scale agriculture applications. Ultimately, a sustainable option with adequate, long-term supply would be preferable.

Bauxite is a mined ore with relatively high aluminum content. As such, it is the main source of material for aluminum metal and alumina production. Unlike refined aluminum, bauxite ore includes many other minerals, including iron oxides and titanium oxides. The aluminum present in bauxite is in the form of various geologic mineral types and polymorphisms, such as gibbsite, boehmite, and diaspore. Despite the conglomerate of materials, bauxites are effective adsorbents and are occasionally utilized in wastewater treatment processes to absorb, but not desorb, phosphates, fluorides, and other contaminants. While bauxite quality and material composition differ around the globe, current worldwide reserve estimates exceed 30 billion tons.

### BRIEF DESCRIPTION OF THE INVENTION

In one exemplary embodiment, dispersible bauxite granules include at least one bauxite domain and at least one supplemental domain selected from the group consisting of at least one nutrient domain, at least one pesticide domain, at least one biological additive domain, at least one sorbent domain, and combinations thereof. The at least one bauxite domain and the at least one supplemental domain are present in the dispersible bauxite granule as distinct domains clustered together.

In another exemplary embodiment, dispersible bauxite granules include bauxite particles and water-soluble binder agglomerating the plurality of bauxite particles into the dispersible bauxite granules, wherein the bauxite particles are free of chemical modification with NaOH.

In another exemplary embodiment, a method for amending soil with bauxite includes applying bauxite to soil, wherein the bauxite is mineral bauxite free of chemical modification with NaOH, the bauxite is mineral bauxite free of chemical modification with NaOH, the bauxite has a moisture content, by weight, of less than 10%, the bauxite has a size of less than 0.6 mm, and the bauxite increases the efficacy of phosphate present in the soil by at least 5%.

Further aspects of the subject matter of the present disclosure are provided by the following clauses:

Dispersible bauxite granules including at least one bauxite domain and at least one supplemental domain selected from the group consisting of at least one nutrient domain, at least one pesticide domain, at least one biological additive domain, at least one sorbent domain, and combinations thereof, wherein the at least one bauxite domain and the at least one supplemental domain are present in the dispersible bauxite granule as distinct domains clustered together.

The dispersible bauxite granules of any preceding clause, wherein the at least one supplemental domain includes the at least one nutrient domain, and the at least one nutrient domain includes at least one additive selected from the group consisting of bioavailable species of phosphorus, molybdenum, selenium, zinc, copper, cobalt, iron, nickel, manganese, vanadium, calcium, potassium, sulfur, chlorine, silicon, magnesium, sodium, nitrogen, boron, and combinations thereof.

The dispersible bauxite granules of any preceding clause, wherein the at least one nutrient domain includes at least one phosphate domain as the bioavailable species of phosphorus.

The dispersible bauxite granules of any preceding clause, wherein the at least one phosphate domain is selected from the group consisting of diammonium phosphate, monoammonium phosphate, triple superphosphate, single superphosphate, and combinations thereof.

The dispersible bauxite granules of any preceding clause, wherein the at least one supplemental domain includes the at least one biological domain, and the at least one biological domain includes at least one additive selected from the group consisting of humics, fulvics, living microbes, microbial metabolites, plant extracts, exogenous plant hormones, and combinations thereof.

The dispersible bauxite granules of any preceding clause, wherein the at least one supplemental domain includes the at least one pesticide domain, and the at least one pesticide domain includes at least one additive selected from the group consisting of herbicides, insecticides, fungicides, nematicides, and combinations thereof.

The dispersible bauxite granules of any preceding clause, wherein the at least one supplemental domain includes the at least one sorbent domain, and the at least one sorbent domain includes at least one additive selected from the group consisting of zeolites, zeotypes, and combinations thereof.

The dispersible bauxite granules of any preceding clause, wherein the at least one supplemental domain includes at least one phosphate domain and at least one of an additional nutrient domain other than a phosphate, the at least one pesticide domain, the at least one biological additive domain, and combinations thereof.

The dispersible bauxite granules of any preceding clause, wherein the dispersible bauxite granules are coherent dispersible bauxite granules and the at least one bauxite domain and the at least one supplemental domain are present in the coherent dispersible bauxite granules as distinct domains coherently agglomerated together such that the coherent dispersible bauxite granules have an intergranular variability in bauxite domain to supplemental domain weight ratio of ±40% and a coherent dispersible bauxite granule crush strength of at least 3 lbf.

The dispersible bauxite granules of any preceding clause, wherein the dispersible bauxite granules are agglomerated dispersible bauxite granules.

The dispersible bauxite granules of any preceding clause, further including at least one layer disposed on the dispersible bauxite granules, the at least one layer being selected from the group consisting of at least one nutrient layer, at least one pesticide layer, at least one biological additive layer, at least one sorbent layer, and combinations thereof.

The dispersible bauxite granules of any preceding clause, wherein the at least one bauxite domain includes an activated bauxite domain.

The dispersible bauxite granules of any preceding clause, wherein the at least one bauxite domain and the at least one supplemental domain are intragranularly homogenously distributed in the dispersible bauxite granules.

The dispersible bauxite granules of any preceding clause, wherein the at least one bauxite domain and the at least one supplemental domain are intergranularly homogenously distributed in the dispersible bauxite granules.

The dispersible bauxite granules of any preceding clause, wherein the dispersible bauxite granules are disposed as a coating layer on a seed.

The dispersible bauxite granules of any preceding clause, wherein the at least one bauxite domain has an alumina content of at least 35 wt % based on the total weight of the at least one bauxite domain.

The dispersible bauxite granules of any preceding clause, wherein the at least one bauxite domain has a combined alumina and iron oxide content of at least 55 wt % based on the total weight of the at least one bauxite domain.

The dispersible bauxite granules of any preceding clause, wherein the at least one bauxite domain includes mineral bauxite free of chemical modification with NaOH.

The dispersible bauxite granules of any preceding clause, wherein the at least one bauxite domain includes at least one of lateritic bauxite or karst bauxite.

The dispersible bauxite granules of any preceding clause, further including at least one of a water-soluble binder, a suspension agent, or an emulsifying agent.

Dispersible bauxite granules including bauxite particles and water-soluble binder agglomerating the plurality of bauxite particles into the dispersible bauxite granules, wherein the bauxite particles are free of chemical modification with NaOH.

The dispersible bauxite granules of any preceding clause, wherein the dispersible bauxite granules are disposed as a coating layer on a seed.

The dispersible bauxite granules of any preceding clause, wherein the bauxite particles have an alumina content of at least 35 wt % based on the total weight of the bauxite particles.

The dispersible bauxite granules of any preceding clause, wherein the bauxite particles have a combined alumina and iron oxide content of at least 55 wt % based on the total weight of the bauxite particles.

The dispersible bauxite granules of any preceding clause, wherein the bauxite particles include at least one of lateritic bauxite or karst bauxite.

The dispersible bauxite granules of any preceding clause, further including at least one of a suspension agent or an emulsifying agent.

The dispersible bauxite granules of any preceding clause, wherein the dispersible bauxite granules have a moisture content, by weight, of less than 10%.

The dispersible bauxite granules of any preceding clause, wherein the dispersible bauxite granules have a size of less than 0.6 mm.

A method for amending soil with bauxite including applying bauxite to soil, wherein the bauxite is mineral bauxite free of chemical modification with NaOH, the bauxite has a moisture content, by weight, of less than 10%, the bauxite has a size of less than 0.6 mm, and the bauxite increases the efficacy of phosphate present in the soil by at least 5%.

The method of any preceding clause, wherein the bauxite is present as at least one bauxite domain in dispersible bauxite granules, the dispersible bauxite granules further including at least one supplemental domain selected from the group consisting of at least one nutrient domain, at least one pesticide domain, at least one biological additive domain, at least one sorbent domain, and combinations thereof, and the at least one bauxite domain and the at least one supplemental domain are present in the dispersible bauxite granule as distinct domains clustered together.

The method of any preceding clause, wherein the at least one supplemental domain includes the at least one nutrient domain, and the at least one nutrient domain includes at least one additive selected from the group consisting of bioavailable species of phosphorus, molybdenum, selenium, zinc, copper, cobalt, iron, nickel, manganese, vanadium, calcium, potassium, sulfur, chlorine, silicon, magnesium, sodium, nitrogen, boron, and combinations thereof.

The method of any preceding clause, wherein the at least one nutrient domain includes at least one phosphate domain as the bioavailable species of phosphorus.

The method of any preceding clause, wherein the at least one phosphate domain is selected from the group consisting of diammonium phosphate, monoammonium phosphate, triple superphosphate, single superphosphate, and combinations thereof.

The method of any preceding clause, wherein the at least one supplemental domain includes the at least one biological domain, and the at least one biological domain includes at least one additive selected from the group consisting of humics, fulvics, living microbes, microbial metabolites, plant extracts, exogenous plant hormones, and combinations thereof.

The method of any preceding clause, wherein the at least one supplemental domain includes the at least one pesticide domain, and the at least one pesticide domain includes at least one additive selected from the group consisting of herbicides, insecticides, fungicides, nematicides, and combinations thereof.

The method of any preceding clause, wherein the at least one supplemental domain includes the at least one sorbent domain, and the at least one sorbent domain includes at least one additive selected from the group consisting of zeolites, zeotypes, and combinations thereof.

The method of any preceding clause, wherein the at least one supplemental domain includes at least one phosphate domain and at least one of an additional nutrient domain other than a phosphate, the at least one pesticide domain, the at least one biological additive domain, and combinations thereof.

The method of any preceding clause, wherein the dispersible bauxite granules are coherent dispersible bauxite granules and the at least one bauxite domain and the at least one supplemental domain are present in the coherent dispersible bauxite granules as distinct domains coherently agglomerated together such that the coherent dispersible bauxite granules have an intergranular variability in bauxite domain to supplemental domain weight ratio of ±40% and a coherent dispersible bauxite granule crush strength of at least 3 lbf.

The method of any preceding clause, wherein the dispersible bauxite granules are agglomerated dispersible bauxite granules.

The method of any preceding clause, further including at least one layer disposed on the dispersible bauxite granules, the at least one layer being selected from the group consisting of at least one nutrient layer, at least one pesticide layer, at least one biological additive layer, at least one sorbent layer, and combinations thereof.

The method of any preceding clause, wherein the at least one bauxite domain includes an activated bauxite domain.

The method of any preceding clause, wherein the at least one bauxite domain and the at least one supplemental domain are intragranularly homogenously distributed in the dispersible bauxite granules.

The method of any preceding clause, wherein the at least one bauxite domain and the at least one supplemental domain are intergranularly homogenously distributed in the dispersible bauxite granules.

The method of any preceding clause, further including at least one of a water-soluble binder, a suspension agent, or an emulsifying agent.

The method of any preceding clause, wherein the bauxite is disposed as a coating layer on a seed.

The method of any preceding clause, wherein the bauxite has an alumina content of at least 35 wt % based on the total weight of the bauxite.

The method of any preceding clause, wherein the bauxite has a combined alumina and iron oxide content of at least 55 wt % based on the total weight of the bauxite.

The method of any preceding clause, wherein the bauxite includes at least one of lateritic bauxite or karst bauxite.

### BRIEF DESCRIPTION OF THE DRAWINGS

These and other features, aspects, and advantages of the present subject matter will become better understood when the following detailed description is read with reference to the accompanying drawings in which:

FIG. 1 is a bar graph showing the effect of application of bauxite on shoot mass of annual ryegrass plants after a 50% reduction in phosphorus, according to an embodiment of the present disclosure.

FIG. 2 is a bar graph showing the combined root and shoot mass of ryegrass following 21 days of growth for treated samples, according to an embodiment of the present disclosure.

FIG. 3 is a bar graph showing the total phosphorus uptake in ryegrass following 21 days of growth or treated samples, according to an embodiment of the present disclosure.

FIG. 4 is a bar graph showing the combined root and shoot biomass of ryegrass following 21 days of growth for treated samples, according to an embodiment of the present disclosure.

FIG. 5 is a bar graph showing the combined root and shoot biomass of ryegrass following 21 days of growth for treated samples, according to an embodiment of the present disclosure.

FIG. 6 is a bar graph showing normalized differential vegetation indices for various small plots treated at different phosphorous application and bauxite granule rates, according to an embodiment of the present disclosure.

FIG. 7 is a bar graph showing phosphate uptake in various small field plots receiving different applications of phosphorus and bauxite, according to an embodiment of the present disclosure.

FIG. 8 is a bar graph showing corn yield in various small plots receiving different applications of phosphorous and bauxite, according to an embodiment of the present disclosure.

### DETAILED DESCRIPTION OF THE INVENTION

Disclosed herein are dispersible bauxite granules and methods for amending soil with bauxite. Embodiments of the present disclosure, in contrast to granules and methods lacking one or more of the features disclosed herein, reduce cost, reduce negative environmental impacts, reduce carbon emissions, reduce production of red mud byproduct, or combinations thereof.

As used herein, “about” indicates a variance of up to 10% from the value being so modified. All values modified with “about” are also intended to convey the unmodified value as an alternative, so that “about 10 μm,” by way of examples, discloses both a range of 9-11 μm as well as specifically 10 μm.

As used herein, “coherent” dispersible granules are differentiated from “agglomerated” dispersible granules in that “agglomerated” refers to granules formed by mechanically agglomerating at least two types of preformed particles together, whereas “coherent” refers to granules formed by agglomerating one type of preformed particle with a second domain of material which is being simultaneously formed. Structural distinctions between coherent dispersible granules and agglomerated dispersible granules include, but are not limited to, greater granule crush strength, improved resistance to attrition, reduced moisture content, greater hygroscopic stability, less intergranular variability in bauxite: supplemental domain weight ratio, greater contact surface area between bauxite and supplemental domains resulting in tighter adhesion, increased bauxite surface area, reduced binder incorporation, a greater degree of intermixed domains, or combinations thereof.

In one embodiment, dispersible bauxite granules include bauxite particles and water-soluble binder agglomerating the plurality of bauxite particles into the dispersible bauxite granules, wherein the bauxite particles are free of chemical modification with NaOH. The bauxite particles may have an alumina content of at least 35 wt % based on the total weight of the bauxite particles, alternatively at least 40 wt %, alternatively at least 45 wt %, alternatively at least 50 wt %, alternatively at least 55 wt %. The bauxite particles may have a combined alumina and iron oxide content of at least 55 wt % based on the total weight of the bauxite particles, alternatively at least 60 wt %, alternatively at least 65 wt %, alternatively at least 70 wt %, alternatively at least 75 wt %. The bauxite particles may include at least one of lateritic bauxite or karst bauxite. The dispersible bauxite granules may further include at least one of a suspension agent or an emulsifying agent. The dispersible bauxite granules may have a moisture content, by weight, of less than 10%, alternatively less than 8%, alternatively less than 6%, alternatively less than 5%, alternatively less than 4%, alternatively less than 3%, alternatively less than 2%, alternatively less than 1%. The dispersible bauxite granule may have any suitable size, including, but not limited to, a size of less than 0.6 mm, alternatively less than 0.5 mm, alternatively less than 0.4 mm, alternatively less than 0.3 mm, alternatively less than 0.2 mm, alternatively less than 0.1 mm.

In one embodiment, dispersible bauxite granules include at least one bauxite domain and at least one supplemental domain selected from the group consisting of at least one nutrient domain, at least one pesticide domain, at least one biological additive domain, at least one sorbent domain, and combinations thereof. The at least one bauxite domain and the at least one supplemental domain are present in the dispersible bauxite granule as distinct domains clustered together. The at least one bauxite domain may include an activated bauxite domain. The activated bauxite may be activated via calcination, acid treatment, or combinations thereof.

The at least one bauxite domain may have any suitable alumina content, including, but not limited to, an alumina content of at least 35 wt % based on the total weight of the at least one bauxite domain, alternatively at least 40 wt %, alternatively at least 45 wt %, alternatively at least 50 wt %, alternatively at least 55 wt %.

The at least one bauxite domain may have any suitable combined alumina and iron oxide content, including, but not limited to, a combined alumina and iron oxide content of at least 55 wt % based on the total weight of the at least one bauxite domain, alternatively at least 60 wt %, alternatively at least 65 wt %, alternatively at least 70 wt %, alternatively at least 75 wt %.

In one embodiment, the at least one bauxite domain includes mineral bauxite free of chemical modification with NaOH. In contrast, bauxite residue (also known as red mud, bauxite tailings, red sludge, or alumina refinery residues) from the processing of bauxite into alumina using the Bayer or similar processes is chemically altered by, inter alia, treatment of the bauxite with NaOH.

The at least one bauxite domain may include any suitable bauxite mineral, including, but not limited to, lateritic bauxite, karst bauxite, or combinations thereof.

The dispersible bauxite granules may further include at least one additional metal oxide domain. Suitable additional metal oxide domains include, but are not limited to, aluminum oxide, α-alumina, β-alumina, γ-alumina, δ-alumina, alumina trihydrate, alumina monohydrate, boehmite, pseudoboehmite, gibbsite, iron oxide, hematite, maghemite, magnetite, goethite, iron hydroxide, calcium oxide, calcium hydroxide, copper oxide, magnesium oxide, manganese oxide, manganese dioxide, nickel oxide, silicon dioxide, zinc oxide, activated metal oxides forms of any of the foregoing, or combinations thereof. The metal oxide may be activated via calcination, acid treatment, or combinations thereof. As used herein, “metal oxide” is understood to be inclusive of metal oxide hydrates and metal oxide hydroxides.

The dispersible bauxite granules may be coherent dispersible bauxite granules or agglomerated dispersible bauxite granules. In one embodiment, wherein the dispersible bauxite granules are coherent dispersible bauxite granules, the at least one bauxite domain and the at least one supplemental domain are present in the coherent dispersible bauxite granules as distinct domains coherently agglomerated together such that the coherent dispersible bauxite granules have an intergranular variability in bauxite domain to supplemental domain weight ratio of ±40% and a coherent dispersible bauxite granule crush strength of at least 3 lbf, alternatively at least 3.5 lbf, alternatively at least 4 lbf, alternatively at least 4.5 lbf, alternatively at least 5 lbf. The coherent dispersible bauxite granules may have reduced intergranular bauxite domain to supplemental domain ratio variability in comparison to otherwise identical agglomerated bauxite dispersible granules, alternatively 5% less intergranular bauxite domain to supplemental domain ratio variability, alternatively 10% less, alternatively 15% less, alternatively 20% less, alternatively 25% less. In one embodiment, the coherent dispersible bauxite granules have an intergranular variability in bauxite domain to supplemental domain weight ratio of ±40%, alternatively±35%, alternatively ±30%, alternatively±25%, alternatively±20%, alternatively±15%. As used herein, intergranular variability is measured relative to the lesser component of bauxite domain and supplemental domain as measured by the average across the coherent dispersible bauxite granules such that if the average bauxite domain: supplemental domain weight ratio is 50:50 with an intergranularity of ±40%, the bauxite domain: supplemental domain weight ratio may range from 30:70 to 70:30. By way of further explanation, if the average bauxite domain: supplemental domain weight ratio is 25:75 with an intergranularity of ±40%, the bauxite domain: supplemental domain weight ratio may range from 15:85 to 35:65.

Structural distinctions between “coherent bauxite dispersible granules” and “agglomerated dispersible bauxite granules” include, but are not limited to, greater granule crush strength, improved resistance to attrition, reduced moisture content, greater hygroscopic stability, less intergranular variability in bauxite domain: supplemental domain weight ratio, greater contact surface area between bauxite and supplemental domains, tighter adhesion between bauxite and supplemental domains, increased bauxite surface area, reduced binder incorporation, a greater degree of intermixed domains, or combinations thereof.

Suitable at least one nutrient domains include, but are not limited to, bioavailable species of phosphorus, molybdenum, selenium, zinc, copper, cobalt, iron, nickel, manganese, vanadium, calcium, potassium, sulfur, chlorine, silicon, magnesium, sodium, nitrogen, boron, or combinations thereof. Bioavailable species of the foregoing nutrients include, but are not limited to, MoO₂⁻, SeO₂⁻, Zn²⁺, ZnCl⁻, CuCO₃, Co²⁺, Fe²⁺, Fe³⁺, Ni²⁺, NiCl⁺, Mn²⁺, MnCl⁺, HVO₄²⁻, Ca²⁺, K+, SO₄²⁻, Cl−, SiOH₄, Mg²⁺, Na⁺, NH⁴⁺, NO₃⁻, H₃BO₃, and B₄O₇²⁻. In one embodiment, the at least one nutrient domain includes at least one phosphate domain as the bioavailable species of phosphorus. Suitable phosphates for the bioavailable species include, but are not limited to, diammonium phosphates (“DAP”), monoammonium phosphates (“MAP”), triple superphosphates (“TSP”), single superphosphates (“SSP”), or combinations thereof.

Suitable at least one biological additive domains include, but are not limited to, humics, fulvics, living microbes, microbial metabolites, plant extracts, exogenous plant hormones, or combinations thereof. Any suitable variations of humic or fulvic acid-containing formulations or any materials of which are organic matter derived and contain numerous humic and/or fulvic acid species may be employed. Microbes may include, but are not limited to, Rhodopseudomonas spp., Bacillus spp., Pseudomonas spp., Saccharomyces spp., Aspergillus spp., Candida spp., Streptococcus spp., Lactobacillus spp., or combinations thereof. Plant extracts may include, but are not limited to, phytohormones, quinols, plastoquinones, flavonoids, plant-growth-promoting metabolites, or combinations thereof. Exogenous plant hormones may include, but are not limited to, IDAA, gibberellin, abscisic acid, auxins, jasmonates, brassinosteroids, cytokinins, salicylic acid, or combinations thereof.

Suitable at least one pesticide domains include, but are not limited to, herbicides, insecticides, fungicides, nematicides, or combinations thereof. Suitable herbicides include, but are not limited to, sulfonylureas, HPPD-inhibitors, chloroacetamides, PPO-inhibitors, phenylurea, triazines, or combinations thereof. Suitable insecticides include, but are not limited to, organophosphates, carbamides, pyrethrins, neonicotinoids, spinosins, indoxacarb, diamides, or combinations thereof. Suitable fungicides include, but are not limited to, strobilurines, pyrimidines, triazoles, dicarboximides, or combinations thereof. Suitable nematicides include, but are not limited to, avermectin, carbamates, organophosphates, or combinations thereof.

The at least one sorbent domain may include, but is not limited to, zeolites, zeotypes, or combinations thereof.

In one embodiment, the at least one supplemental domain includes at least one phosphate domain and at least one of, at least two of, or each of, an additional nutrient domain other than a phosphate, the at least one pesticide domain, the at least one biological additive domain, or combinations thereof.

The dispersible bauxite granules may include at least one layer disposed on the dispersible bauxite granules, wherein the at least one layer is at least one nutrient layer, at least one pesticide layer, at least one biological additive layer, at least one sorbent layer, or combinations thereof.

The at least one bauxite domain and the at least one supplemental domain may be intragranularly homogenously or heterogeneously distributed in the dispersible bauxite granules. The at least one bauxite domain and the at least one supplemental domain may be intergranularly homogenously or heterogeneously distributed in the dispersible bauxite granules.

The dispersible bauxite granules may be disposed as a coating layer on a seed.

In one embodiment, each of the at least one bauxite domain is at least 50% surrounded by the at least one supplemental domain, alternatively at least 60% surrounded, alternatively at least 70% surrounded, alternatively at least 80% surrounded, alternatively at least 90% surrounded, alternatively at least 95% surrounded, alternatively at least 99% surrounded, alternatively entirely surrounded.

The dispersible bauxite granules may have any suitable weight ratio of bauxite to supplemental domain, including, but not limited to, a weight ratio of 10:1 to 1:10, alternatively 8:1 to 1:8, alternatively 7:1 to 1:7, alternatively 6:1 to 1:6, alternatively 5:1 to 1:5, alternatively 4:1 to 1:4, alternatively 3:1 to 1:3, alternatively 2:1 to 1:2, alternatively 3:1 to 1:1, alternatively 1:1 to 1:3, alternative about 2:1, alternatively about 1:1, alternatively about 1:2, or any sub-range or combination of ranges thereof.

The dispersible bauxite granules may include at least one of a water-soluble binder, a suspension agent, or an emulsifying agent. In one embodiment, the dispersible bauxite granules include, by weight, 1-40% water-soluble binder, alternatively 5-35%, alternatively 5-15%, alternatively 10-20%, alternatively 15-25%, alternatively 20-30%, alternatively 25-35%, or any sub-range or combination thereof. Suitable water-soluble binders include, but are not limited to, calcium lignosulfonate, ammonium lignosulfonate, or combinations thereof. Suitable suspension agents include, but are not limited to, polysaccharides, inorganic salts, carbomers, or combinations thereof. Suitable emulsifying agents include, but are not limited to, vegetable derivatives such as acacia, tragacanth, agar, pectin, carrageenan, or lecithin, animal derivatives such as gelatin, lanolin, or cholesterol, semi-synthetic agents such as methylcellulose, or carboxymethylcellulose, synthetics such as benzalkonium chloride, benzethonium chloride, alkali soaps (including sodium or potassium oleate), amine soaps (including triethanolamine stearate), detergents (including sodium lauryl sulfate, sodium dioctyl sulfosuccinate, or sodium docusate), sorbitan esters, polyoxyethylene derivatives of sorbitan esters, glyceryl esters, or combinations thereof.

The dispersible bauxite granules may further include at least one additional domain present as a distinct domain. Suitable additional domains include, but are not limited to, at least one nutrient domain, at least one pesticide domain, at least one biological additive domain, at least one sorbent domain or combinations thereof. The at least one additional domain may be coherently agglomerated with the at least one bauxite domain and the at least one supplemental domain in the dispersible bauxite granules, the at least one additional domain may be agglomerated with the coherently agglomerated with the at least one bauxite domain and the at least one supplemental domain in the dispersible bauxite granules, the at least one additional domain may be coated onto the dispersible bauxite granules, the at least one additional domain may be intermixed with the dispersible bauxite granules, or combinations thereof.

Bauxite particles constituting the at least one bauxite domain may have any suitable size, including, but not limited to, smaller than about 300 μm, alternatively smaller than about 150 μm, alternatively smaller than about 100 μm, alternatively smaller than about 75 μm, alternatively smaller than about 50 μm, alternatively smaller than about 25 μm, or smaller, or any sub-range or combination thereof.

In one embodiment, the dispersible bauxite granules include, by weight, 5-80% bauxite domain, 10-95% supplemental domain, and, optionally, 1-50% water-soluble binder, alternatively 30-40% bauxite domain, 30-40% supplemental domain, and 20-40% water-soluble binder, alternatively 35% bauxite domain, 35% supplemental domain, and 30% water-soluble binder. In a further embodiment, the dispersible bauxite granules include by weight, 5-70% bauxite domain, 10-70% supplemental domain, up to 50% water-soluble binder, and up to 20% surfactants and emulsifiers combined, alternatively consist of, by weight, 5-50% bauxite domain, 10-50% supplemental domain, up to 50% water-soluble binder, and up to 5% surfactants and emulsifiers combined.

The dispersible bauxite granules may have any suitable size (as measured by diameter based upon the median within the sample). Suitable sizing for the dispersible bauxite granules may include, but is not limited to, about 0.4 mm to about 4.0 mm, alternatively about 0.4 mm to about 1.2 mm, alternatively about 0.9 mm to about 1.5 mm, alternatively about 1.2 mm to about 1.8 mm, alternatively about 1.5 mm to about 2.1 mm, alternatively about 1.8 mm to about 2.4 mm, alternatively about 2.1 mm to about 2.7 mm, alternatively about 2.4 mm to about 3.0 mm, alternatively about 2.7 mm to about 3.3 mm, alternatively about 3.0 mm to about 3.6 mm, alternatively about 3.3 mm to about 4.0 mm, alternatively about 0.4 mm, alternatively about 0.5 mm, alternatively about 0.6 mm, alternatively about 0.7 mm, alternatively about 0.8 mm, alternatively about 0.9 mm, alternatively about 1.0 mm, alternatively about 1.1 mm, alternatively about 1.2 mm, alternatively about 1.3 mm, alternatively about 1.4 mm, alternatively about 1.5 mm, alternatively about 1.6 mm, alternatively about 1.7 mm, alternatively about 1.8 mm, alternatively about 1.9 mm, alternatively about 2.0 mm, alternatively about 2.1 mm, alternatively about 2.2 mm, alternatively about 2.3 mm, alternatively about 2.4 mm, alternatively about 2.5 mm, alternatively about 2.6 mm, alternatively about 2.7 mm, alternatively about 2.8 mm, alternatively about 2.9 mm, alternatively about 3.0 mm, alternatively about 3.1 mm, alternatively about 3.2 mm, alternatively about 3.3 mm, alternatively about 3.4 mm, alternatively about 3.5 mm, alternatively about 3.6 mm, alternatively about 3.7 mm, alternatively about 3.8 mm, alternatively about 3.9 mm, alternatively about 4.0 mm, alternatively more than about 4.0 mm, or any sub-range or combination thereof. In one non-limiting example, golf greens may use dispersible bauxite granules of about 0.5 mm to about 0.8 mm. In another non-limiting example, corn may use dispersible bauxite granules via a broadcast application of about 2.4 mm. In a third non-limiting example, any crop with a strip-till machine application may use dispersible bauxite granules of about 1.5 mm. In one embodiment, suitable, for example, for application as a suspension, the dispersible bauxite granules are micronized, and have a particle size less than about 200 μm, alternatively less than about 150 μm, alternatively less than about 100 μm, alternatively less than about 75 μm, alternatively less than about 1 μm, alternatively less than about 1 μm, alternatively less than about 50 μm, alternatively less than about 25 μm, alternatively less than about 10 μm, alternatively less than about 5 μm, alternatively less than about 2 μm, alternatively less than about 1 μm, alternatively less than about 0.75 μm, alternatively less than about 0.5 μm, alternatively less than about 0.25 μm, alternatively less than about 0.1 μm, alternatively less than about 0.05 μm, alternatively less than about 0.01 μm, as measured by largest particle dimension.

In one embodiment, a method for forming coherent dispersible bauxite granules includes mixing phosphoric acid and sulfuric acid in an acid surge tank, reacting the phosphoric acid with ammonia in the presence of the sulfuric acid in a reactor vessel to form ammonium phosphate, introducing bauxite particles into the presence of the ammonium phosphate, co-agglomerating the ammonium phosphate and the bauxite particles in a rotary drum ammoniator-granulator to form coherent dispersible bauxite granules, and drying the coherent dispersible bauxite granules, wherein the at least one bauxite domain and the at least one supplemental (phosphate) domain are present in the coherent dispersible granules as distinct domains coherently agglomerated together.

In one embodiment, a method for forming coherent dispersible granules includes mixing phosphoric acid and ground phosphate rock in a reactor, feeding the slurry into a granulator, introducing bauxite particles into the presence of the agglomerating superphosphate, co-agglomerating the superphosphate and the bauxite particles in the granulator to form the coherent dispersible bauxite granules, and drying the coherent dispersible bauxite granules, wherein the at least one bauxite domain and the at least one supplemental (phosphate) domain are present in the coherent dispersible bauxite granules as distinct domains coherently agglomerated together.

Introducing the bauxite particles into the presence of the ammonium phosphate may include premixing the bauxite particles with the phosphoric acid prior to reacting the phosphoric acid with the ammonia, adding the bauxite particles into the acid surge tank, adding the bauxite particles into the reactor vessel, adding the bauxite particles into the rotary drum ammoniator-granulator, or any combination thereof. In one embodiment, the bauxite particles are maintained within a pH range of about 1.5 to about 7.5 from introduction through coherent agglomeration, alternatively about 1.5 to 2.5, alternatively about 2 to 3, alternatively about 2.5 to 3.5, alternatively about 3 to 4, alternatively about 3.5 to 4.5, alternatively about 4 to 5, alternatively about 4.5 to 5.5, alternatively about 5 to 6, alternatively about 5.5 to 6.5, alternatively about 6 to 7, alternatively about 6.5 to 7.5, or any sub-range or combination thereof.

Drying the coherent dispersible bauxite granules may include drying the coherent dispersible bauxite granules in a rotary dryer. Further bauxite particles may be introduced into the rotary dryer to be dried and further agglomerated with the coherent dispersible bauxite granules.

In one embodiment, a method for amending soil with bauxite includes applying bauxite to soil, wherein the bauxite is mineral bauxite free of chemical modification with NaOH. The bauxite may have any suitable moisture content, including, but not limited to, a moisture content, by weight, of less than 10%, alternatively less than 8%, alternatively less than 6%, alternatively less than 5%, alternatively less than 4%, alternatively less than 3%, alternatively less than 2%, alternatively less than 1%. The bauxite may have any suitable size, including, but not limited to, a size of less than 0.6 mm, alternatively less than 0.5 mm, alternatively less than 0.4 mm, alternatively less than 0.3 mm, alternatively less than 0.2 mm, alternatively less than 0.1 mm. The bauxite increases the efficacy of phosphate present in the soil by at least 5%, alternatively at least 10%, alternatively at least 15%, alternatively at least 20%, alternatively at least 25%, alternatively at least 30%, alternatively at least 35%, alternatively at least 40%, alternatively at least 45%, alternatively at least 50%. As used herein, increasing the efficacy of the phosphate present in the soil means that, for plants grown in the soil at a particular phosphate loading, at least one of the shoot mass or the root mass yielded is increased by the recited amount as a measure of efficacy.

The bauxite may be applied to the soil by any suitable technique, including, but not limited to, a no-till application, a till application, an in-furrow application, or combinations thereof. In one embodiment, the bauxite is applied to a non-bauxitic soil.

The bauxite may be present as at least one bauxite domain in dispersible bauxite granules, the dispersible bauxite granules further including at least one supplemental domain selected from the group consisting of at least one nutrient domain, at least one pesticide domain, at least one biological additive domain, at least one sorbent domain, and combinations thereof, and the at least one bauxite domain and the at least one supplemental domain are present in the dispersible bauxite granule as distinct domains clustered together, as further described above.

The bauxite may be applied as a coating layer on a seed, and then applied to the soil by distribution of such coated seeds into the soil.

The bauxite may have any suitable alumina content, including, but not limited to, an alumina content of at least 35 wt % based on the total weight of the at least one bauxite domain, alternatively at least 40 wt %, alternatively at least 45 wt %, alternatively at least 50 wt %, alternatively at least 55 wt %.

The bauxite may have any suitable combined alumina and iron oxide content, including, but not limited to, a combined alumina and iron oxide content of at least 55 wt % based on the total weight of the at least one bauxite domain, alternatively at least 60 wt %, alternatively at least 65 wt %, alternatively at least 70 wt %, alternatively at least 75 wt %.

The bauxite may be free of chemical modification with NaOH. The bauxite domain may be lateritic bauxite, karst bauxite, or combinations thereof. The bauxite may include at least one of a water-soluble binder, a suspension agent, or an emulsifying agent.

### Examples

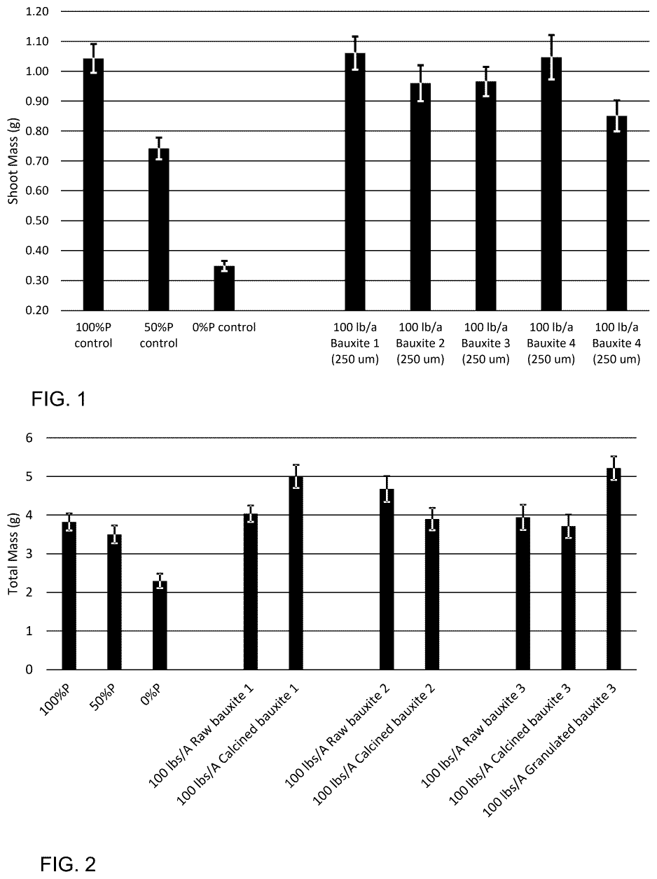

Referring to FIG. 1, a 21-day grow room trial involving annual ryegrass was performed in pots, where phosphorus levels were modified. Various raw bauxite sources and alumina were applied as 250 μm (−60 mesh) powders at a converted rate of 100 lb/acre. Plant shoot mass data suggested that soil supplementation with raw bauxite powder enabled similar shoot growth with only 50% of the applied P₂O₅ relative to a control.

### Experimental Methods

### Grow Room Studies:

Bauxites (Bauxite #1, Bauxite #2, Bauxite #3, Bauxite #4, and Bauxite #5) were prepared for plant grow room studies by grinding and sieving the resulting powders through a specified mesh size. Test treatments (Bauxite+reduced phosphorus) were compared to a negative reference (no phosphate fertilizer) and to two positive references (100% and 50% phosphorous controls). Bauxite #1, Bauxite #2, Bauxite #3, Bauxite #4, and Bauxite #5 were bauxites from different geographical regions.

The agronomic efficiency of bauxites was investigated in a pot experiment with perennial ryegrass (Lolium perenne L.), conducted in a grow room facility with controlled conditions. Plant growth testing conditions included a mixture of graded fine 100% sand and peat moss at a 13.33:1 sand: peat ratio as the soil (with 75 wt % water, low nitrogen (10 kg N/ha), reduced phosphorus (100% phosphorous was defined as 45.4 kg P₂O₅/ha), and low potassium (10 kg K₂O/ha) disposed in six-inch square pots having 900 g medium per pot with 127.69 cm² surface area. Ten replications per treatment were performed with 0.5 g seeds per pot. The light source was 300-350 μmol/m²/s with a 16-hour light and 8-hour dark cycle at 28° C. under light and 22° C. under dark. Fertilizer was applied (10-0-32 (N—P₂O₅—K₂O) at a rate of 0.1 g per pot once upon planting; monoammonium phosphate 11-52-0 (N—P₂O₅—K₂O) at varying rates of P₂O₅ per pot once upon planting, urea 46-0-0 (N—P₂O₅—K₂O) was supplemented as needed once upon planting to ensure a total of 0.032 g N per pot). On Day 10, the growth was thinned to 30 seedlings per pot to standardize subsequent biomass increase for comparison. Growth was monitored for 21 days total, and both root and shoot biomass were analyzed.

### Small-Plot Field Trial:

A small-plot field trial was conducted to evaluate the effect of various rates of granular bauxite on corn (#2 yellow dent) yields with reduced phosphorous fertilizer rates. (50% and 25%). Control checks were established at 100% phosphorous grower standard practice as well as at both 50% phosphorous and 25% phosphorous levels. This trial was a randomized complete block design (“RCBD”) with 10 treatments and 6 repetitions per treatment. Each plot was four rows wide and 40 feet long. Only yield data from the central two rows of each plot was taken to avoid treatment effect overlap that may be seen on the plot edges. The trial was conducted by a third-party research organization in Troy, OH. Reported site soil conditions were 40 ppm phosphorous, 3.8% organic material, and pH 5.4.

Referring to FIG. 2, the combined root and shoot mass of ryegrass following 21 days of growth for each of the treated samples was measured. Despite only receiving 50% of the phosphorous application compared to the 100% phosphorous control, samples that received co-application with a raw, calcined, or granulated bauxite maintained statistical equivalence (or exceeded) the 100% phosphorous application control.

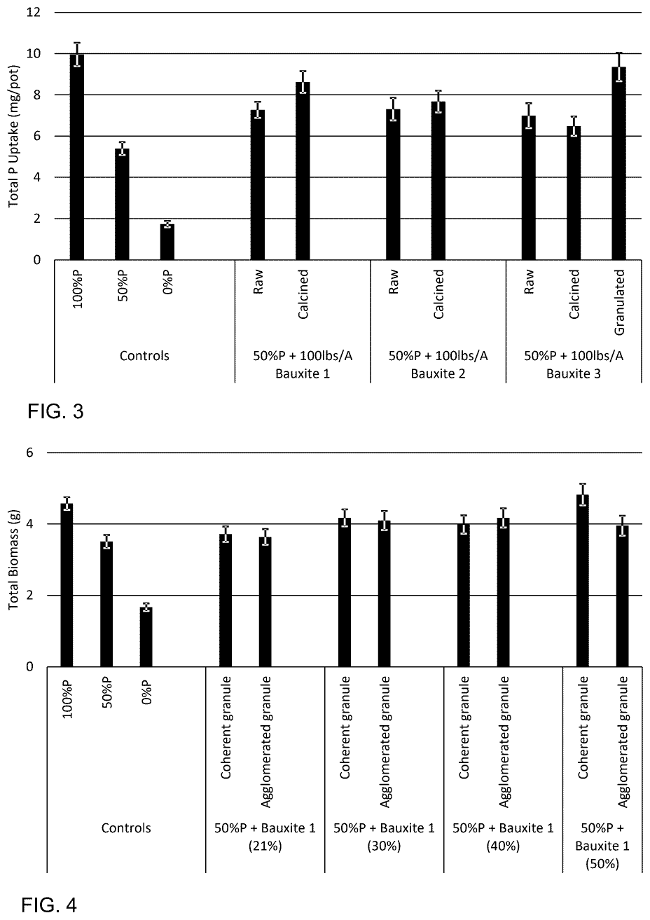

Referring to FIG. 3, the total phosphorous uptake in ryegrass following 21 days of growth for each of the treated samples as measured. Despite only receiving 50% of the phosphorous application compared to the 100% phosphorous control, samples that received co-application with a raw, calcined, or granulated bauxite showed increased phosphorous uptake compared to the 50% phosphorous control.

Referring to FIG. 4, the combined root and shoot biomass of ryegrass following 21 days of growth for each of the treated samples was measured. The percentages in parentheses refer to the input concentration of bauxite into the manufacturing process. Despite only receiving 50% of the phosphorous application compared to the 100% phosphorous control in a form where the bauxite and the phosphorous source were co-granulated within a single granule, samples that received application of the bauxite co-granules maintained statistical equivalence (or exceeded) the 100% phosphorous application control. A trend persisted that greater bauxite inclusion rates within the granules resulted in greater biomass, regardless of whether granulation occurred via chemical or agglomeration-based granulation methods.

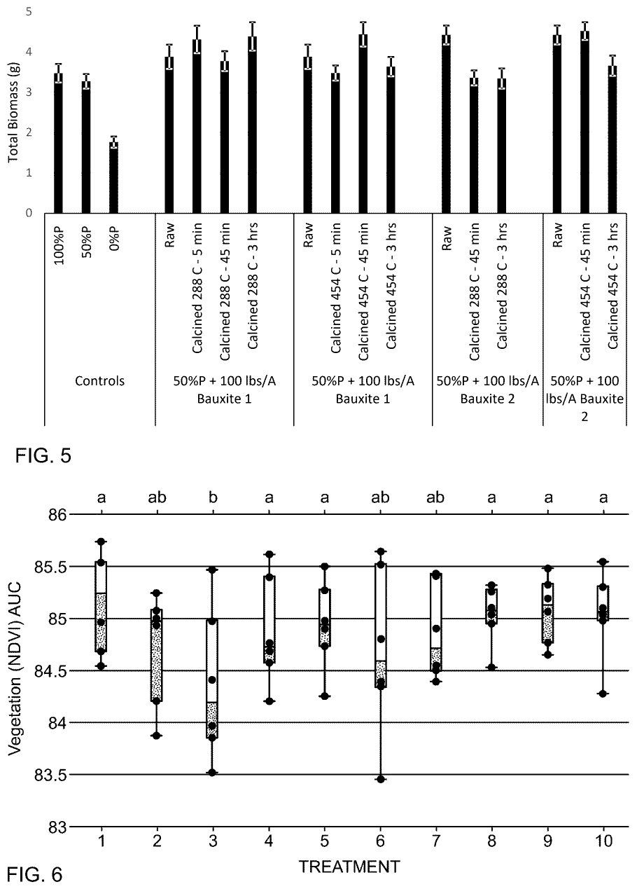

Referring to FIG. 5, the combined root and shoot biomass of ryegrass following 21 days of growth for each of the treated samples was measured. Despite only receiving 50% of the phosphorous application compared to the 100% phosphorous control, each of the samples that received co-application with a raw bauxite maintained statistical equivalence (or exceeded) the 100% phosphorous application control. Calcination of the raw bauxite under various time and temperature conditions showed no statistical impact on biomass.

TABLE 1
Treatments of various small agricultural corn plots in Sidney, Ohio
(weights indicate an application rate of pounds per acre (lb/ac)).

| # | Treatment |
|---|---|
| 1 | 100% Phosphorus Control |
| 2 | 50% Phosphorus Control |
| 3 | 25% Phosphorus Control |
| 4 | 50% Phosphorus and 100 lbs. Granular Bauxite |
| 5 | 50% Phosphorus and 50 lbs. Granular Bauxite |
| 6 | 50% Phosphorus and 37.5 lbs. Granular Bauxite |
| 7 | 50% Phosphorus and 25 lbs. Granular Bauxite |
| 8 | 50% Phosphorus and 12.5 lbs. Granular Bauxite |
| 9 | 25% Phosphorus and 100 lbs. Granular Bauxite |
| 10 | 25% Phosphorus and 50 lbs. Granular Bauxite |

Referring to FIG. 6, normalized differential vegetation indices (“NDVI”) for the various small plots treated at different phosphorous application and bauxite granule rates were measured. Despite receiving only 50% or 25% of the phosphorous application compared to the 100% phosphorous plots, plots that received the granular bauxite application showed no statistical difference than the plots receiving 100% phosphorous application.

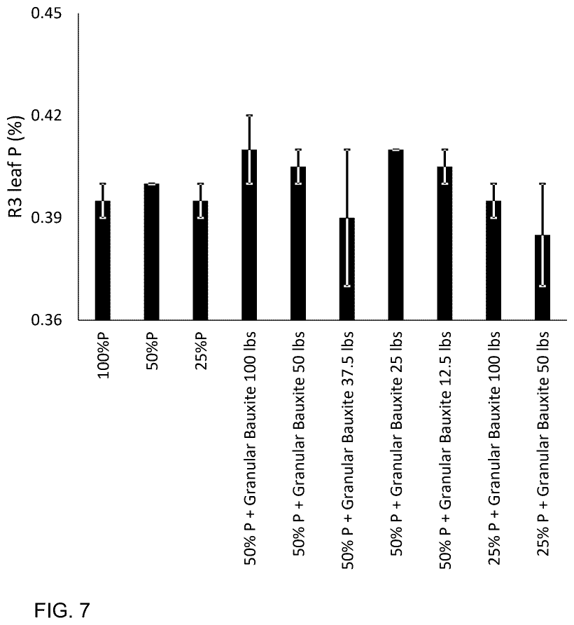

Referring to FIG. 7, phosphate uptake in the various small field plots receiving different applications of phosphorous and bauxite was measured. Despite only receiving 50% or 25% of the phosphorous application compared to the 100% phosphorous control, each of the plot groups that received co-application with a raw bauxite maintained statistical equivalence (or exceeded) the 100% phosphorous application control plots.

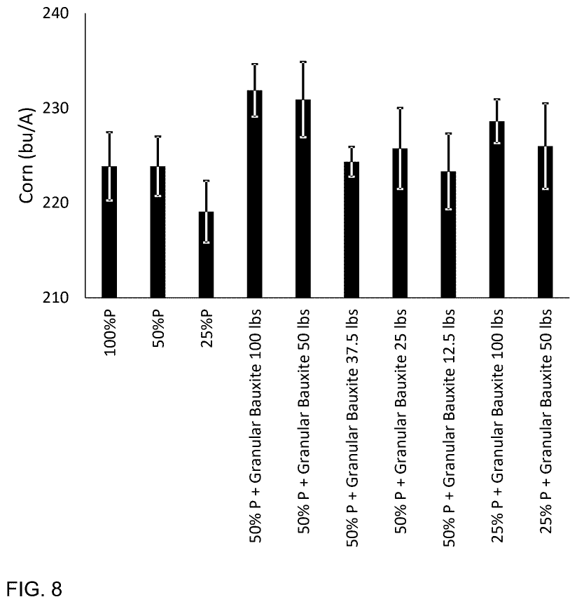

Referring to FIG. 8, corn yield in the various small plots receiving different applications of phosphorous and bauxite were measured. Despite only receiving 50% or 25% of the phosphorous application compared to the 100% phosphorous control, each of the plot groups that received co-application with a raw bauxite maintained statistical equivalence (or exceeded) the 100% phosphorous application control plots. A clear trend was observed where greater application rates of granular bauxites resulted in higher yields, dependent upon the phosphorus application rate.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. Dispersible bauxite granules, comprising:
at least one bauxite domain; and
at least one supplemental domain selected from the group consisting of at least one nutrient domain, at least one pesticide domain, at least one biological additive domain, at least one sorbent domain, and combinations thereof,
wherein the at least one bauxite domain and the at least one supplemental domain are present in the dispersible bauxite granule as distinct domains clustered together.

2. The dispersible bauxite granules of claim 1, wherein the at least one supplemental domain includes the at least one nutrient domain, and the at least one nutrient domain includes at least one additive selected from the group consisting of bioavailable species of phosphorus, molybdenum, selenium, zinc, copper, cobalt, iron, nickel, manganese, vanadium, calcium, potassium, sulfur, chlorine, silicon, magnesium, sodium, nitrogen, boron, and combinations thereof.

3. The dispersible bauxite granules of claim 2, wherein the at least one nutrient domain includes at least one phosphate domain as the bioavailable species of phosphorus, the at least one phosphate domain is selected from the group consisting of diammonium phosphate, monoammonium phosphate, triple superphosphate, single superphosphate, and combinations thereof.

4. (canceled)

5. (canceled)

6. (canceled)

7. (canceled)

8. (canceled)

9. The dispersible bauxite granules of claim 1, wherein the dispersible bauxite granules are coherent dispersible bauxite granules and the at least one bauxite domain and the at least one supplemental domain are present in the coherent dispersible bauxite granules as distinct domains coherently agglomerated together such that the coherent dispersible bauxite granules have an intergranular variability in bauxite domain to supplemental domain weight ratio of ±40% and a coherent dispersible bauxite granule crush strength of at least 3 lbf.

10. The dispersible bauxite granules of claim 1, wherein the dispersible bauxite granules are agglomerated dispersible bauxite granules.

11. (canceled)

12. (canceled)

13. The dispersible bauxite granules of claim 1, wherein the at least one bauxite domain and the at least one supplemental domain are intragranularly homogenously distributed in the dispersible bauxite granules.

14. The dispersible bauxite granules of claim 1, wherein the at least one bauxite domain and the at least one supplemental domain are intergranularly homogenously distributed in the dispersible bauxite granules.

15. (canceled)

16. The dispersible bauxite granules of claim 1, wherein the at least one bauxite domain has an alumina content of at least 35 wt % based on the total weight of the at least one bauxite domain.

17. The dispersible bauxite granules of claim 1, wherein the at least one bauxite domain has a combined alumina and iron oxide content of at least 55 wt % based on the total weight of the at least one bauxite domain.

18. The dispersible bauxite granules of claim 1, wherein the at least one bauxite domain includes mineral bauxite free of chemical modification with NaOH.

19. The dispersible bauxite granules of claim 1, wherein the at least one bauxite domain includes at least one of lateritic bauxite or karst bauxite.

20. The dispersible bauxite granules of claim 1, further including at least one of a water-soluble binder, a suspension agent, or an emulsifying agent.

21. Dispersible bauxite granules, comprising:
bauxite particles; and
water-soluble binder agglomerating the plurality of bauxite particles into the dispersible bauxite granules,
wherein the bauxite particles are free of chemical modification with NaOH.

22. (canceled)

23. The dispersible bauxite granules of claim 21, wherein the bauxite particles have an alumina content of at least 35 wt % based on the total weight of the bauxite particles.

24. The dispersible bauxite granules of claim 21, wherein the bauxite particles have a combined alumina and iron oxide content of at least 55 wt % based on the total weight of the bauxite particles.

25. The dispersible bauxite granules of claim 21, wherein the bauxite particles include at least one of lateritic bauxite or karst bauxite.

26. The dispersible bauxite granules of claim 21, further including at least one of a suspension agent or an emulsifying agent.

27. The dispersible bauxite granules of claim 21, wherein the dispersible bauxite granules have a moisture content, by weight, of less than 10%.

28. The dispersible bauxite granules of claim 21, wherein the dispersible bauxite granules have a size of less than 0.6 mm.

29. A method for amending soil with bauxite, comprising:
applying bauxite to soil,
wherein:
the bauxite is mineral bauxite free of chemical modification with NaOH;
the bauxite has a moisture content, by weight, of less than 10%;
the bauxite has a size of less than 0.6 mm; and
the bauxite increases the efficacy of phosphate present in the soil by at least 5%.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)
